(19) United States
(12) Patent Application Publication
(10) Pub. No.: US 2026/0152427 A1
(43) Pub. Date: Jun. 4, 2026

(54) HAMMER MILL PROCESS FOR FORMING UNIFORM FOAMED GLASS AGGREGATE PRODUCTS AND METHOD OF FORMING BLENDS OF UNIFORM FOAMED GLASS AGGREGATE PRODUCTS

(71) Applicant: Allied Landscape & Contractor Supply Co., Dresher, PA (US)

(72) Inventor: William J. Murwin, III, Ambler, PA (US)

(21) Appl. No.: 19/407,652

(22) Filed: Dec. 3, 2025

Related U.S. Application Data
(60) Provisional application No. 63/727,395, filed on Dec. 3, 2024.

(51) Int. Cl. C03B 19/08

(52) U.S. Cl. CPC C03B 19/08

(57) ABSTRACT

A method for forming uniform foamed glass aggregate product includes the steps of
a. providing a base foamed glass product;
b. feeding the base foamed aggregate product to a hammer mill having an outlet sieve;
c. processing the base foamed aggregate product in the hammer mill;
d. extracting foamed aggregate product from the hammer mill; and
e. separating the foamed aggregate product from the hammer mill into at least two product mixes of distinct diameter ranges.

### RELATED APPLICATION

The present claims priority to of U.S. Patent Application 63/727,395 filed Dec. 3, 2024, titled “Hammer Mill Process for Forming Uniform Foamed Glass Aggregate Products and Method of Forming Blends of Uniform Foamed Glass Aggregate Products” which application is incorporated herein by reference.

### BACKGROUND OF THE INVENTION

### 1. Field of the Invention

The present invention relates to foamed glass aggregate products, more particularly to hammer mill process for forming uniform foamed glass aggregate products and method of forming blends of uniform foamed glass aggregate products.

### 2. Background Information

Foamed glass aggregate can go by a variety of names including foam glass gravel, cellular glass or FGA. Foamed glass aggregate is a lightweight, thermally insulating aggregate made from recycled glass powder. It has been used in many construction applications including as lightweight fill in embankments, as thermal insulation underneath a concrete slab, and as lightweight green roof fill. Foamed glass aggregate is an ideal building material to solve some of the construction industry's most pervasive issues.

Foamed glass aggregate is conventionally made entirely from recycled glass, whereby it's embodied carbon profile is incredibly low. Thus, foamed glass aggregate is one of the most environmentally sustainable building materials on the market. As a generic overview foamed glass aggregate begins as post-consumer recycled glass. The recycled glass is cleaned to generally about <1% non-glass to eliminate contaminants that may alter the consistency of the finished foamed glass aggregate product. The cleaned glass is milled into a superfine powder, which is then measured and mixed with a foaming agent prior to being kiln-fired.

Common foaming agents include carbonates, sulfates, silicates, and various carbon-based materials, such as coke, anthracite, soot, graphite, and silicon carbide (SiC). Conventional foaming agents are typically chemical reagents. However, various waste materials as alternatives to chemical reagents for foam glass production have been proposed, and these materials include marble cutting sludge, aluminum dross, ark clam shell, eggshell, oyster shell, banana leaves, yerba matte, expandable polystyrene, pine scales and silicone cutting waste.

Once the glass powder and foaming agent mixture is prepared, it's deposited onto a conveyor, which moves slowly through the kiln at a specific thermal profile to slowly heat the glass powder and foaming agent mixture to 1,500°. The glass powder softens as it heats, causing a chemical reaction with the foaming agent that foams up the mixture and creates a network of closed cell micropores. After exiting the kiln, the material emerges as a thick foam glass slab. The slab quickly begins breaking and cracking due to thermal stress from the exposure to ambient temperature air. Over the next few minutes of cooling, the aggregate pieces (reference numeral 10 in the drawings) continue to fracture until the particle sizes are about 1″-3″ in diameter. At the far end of the cooling table, pieces are discharged onto a conveyor system, where they're sent to bagging or storage.

For more detailed background see former Pittsburgh Corning Corporation U.S. Pat. Nos. 2,620,597 and 2,758,937 “Method of Preparing Cellular Glass” and “Production of Cellulated Glass”; and also U.S. Pat. Nos. 3,951,632, 4,347,326, and 5,516,351.

One current commercial use of foamed glass aggregate is as a sub-slab insulator. For example, foamed glass aggregate may be used as a 2-1 replacement for rigid foam board and crushed stone aggregate. With a compressive strength of 116 psi at 10% deformation, this product can be used beneath structural footings as well as on the exterior of a stem wall for additional insulation. At R1.7 per installed inch, foamed glass aggregate can perform as both insulation and drainage in commercial and residential installations.

another early commercial use of foamed glass aggregate was as insulation tile. Former Pittsburgh Corning Corporation developed and marketed a foamed glass insulating tile product which is described in U.S. Pat. Nos. 3,959,541, 4,119,422, 4,198,224, 4,571,321 and 4,623,585. As the purpose of this tile was to be used as thermal insulation, it lacked surface strength, and can be dented very easily.

Another use of foamed glass aggregate is in green roofing applications and green landscape applications. Weighing only 10 pounds per cubic foot, foamed glass aggregate is 90% lighter than traditional gravel aggregate fill. Installing foamed glass aggregate as fill for a green roof reduces building strain and increases the ability to build creative landscapes. Foamed glass aggregate can also be compacted at in slopes up to 45° which gives landscape architects the ability to introduce slope and creativity into designs.

U.S. Pat. No. 7,695,560 discloses a composite concrete building material comprising cementitious materials; and foam glass aggregates. The cementitious materials may comprise cement, sand and fly ash. The cementitious materials may also comprise other materials, including, for example, reinforcing fibers. In one embodiment the reinforcing fibers are comprised of one or more of the following materials: glass, steel, titanium, other metals, carbon, or Kevlar. The foam glass aggregates may have a closed pore structure and average pore size of 1.0 mm or less, wherein said average pore size is measured based on the distance between two farthest points of pore surface. The foam glass aggregate may have an average density of 30 to 100 PCF. The foam glass aggregate may have a compression strength of 2000 PSI or greater. The foam glass aggregates may be on average between 0.1 inches and approximately 2.0 inches in their largest diameter.

U.S. Pat. No. 11,858,657 discloses a method of making a roadbed, including paving an area with foamed glass aggregate to define a bed and covering the bed with a layer of cementitious material to define a composite bed. The composite bed is at least 85 percent foamed glass aggregate. The composite bed has a cementitious surface.

The above discussions are merely to give a breadth of the uses of foamed glass aggregate, and the patents are incorporated herein by reference. As a lightweight fill, foamed glass aggregate can address many of the challenges that the infrastructure world faces today and has been utilized, as noted above, in lightweight fill for highways, green roofs, and in lightweight concrete, bridge abutments, and additionally it has been used in retaining walls and foundations. Whether that is decreasing structural loads, reducing load settlements on soft soils, or stabilizing embankments, foamed glass aggregate can be a solution to a variety of the civil world's problems.

There has been a desire to effectively and efficiently create foamed glass aggregate products to increase the potential applications of foamed glass aggregate. Processing the aggregate to distinct material sizes has been proposed but efficient and effective solutions have proven difficult. For example, processing techniques utilizing a Jaw Crusher, an Impact crusher, and a Cone Crusher did not work effectively or efficiently. The aggregate products desire to avoid a spherical or cube shape of the aggregate as it can decrease the product usefulness.

There remains a need in the art for forming uniform foamed glass aggregate products in efficient and effect manners.

### SUMMARY OF THE INVENTION

The various embodiments and examples of the present invention as presented herein are understood to be illustrative of the present invention and not restrictive thereof and are non-limiting with respect to the scope of the invention.

It is an object of the present invention to eliminate the above-mentioned drawbacks by providing a method for forming uniform foamed glass aggregate product comprising the steps of
a. providing a base foamed glass product;
b. feeding the base foamed aggregate product to a hammer mill having an outlet sieve;
c. processing the base foamed aggregate product in the hammer mill;
d. extracting foamed aggregate product from the hammer mill; and
e. separating the foamed aggregate product from the hammer mill into at least two product mixes of distinct diameter ranges.

The method for forming uniform foamed glass aggregate product according one aspect of the invention provides wherein the base foamed glass product is a foamed glass aggregate product.

The method for forming uniform foamed glass aggregate product according one aspect of the invention provides wherein the base foamed glass product is treated with an aqueous solution prior to processing the base foamed aggregate product in the hammer mill, and wherein the aqueous solution is applied by a treatment sprayer and includes a waterborne resinous filler.

The method for forming uniform foamed glass aggregate product according one aspect of the invention provides wherein the hammer mill is a horizontal hammer mill with a gravity feed.

The method for forming uniform foamed glass aggregate product according one aspect of the invention provides wherein the step of separating the foamed aggregate product from the hammer mill is into at least three, and preferably at least four product mixes of distinct diameter ranges.

The method for forming uniform foamed glass aggregate product according one aspect of the invention provides wherein the step of separating the foamed aggregate product from the hammer mill includes directing the foamed aggregate product from the hammer mill to a four-chamber separator that will separate into four product mixes.

The method for forming uniform foamed glass aggregate product according one aspect of the invention provides wherein the invention further includes the step of blending a plurality of the four product mixes into a blended foamed aggregate product.

It is an object of the present invention to eliminate the above-mentioned drawbacks by providing a method of forming blends of uniform foamed glass aggregate products comprising the steps of providing at least four product mixes of foamed glass aggregate products of distinct diameter ranges comprising combining at least two of the product mixes of foamed glass aggregate products of distinct diameter ranges into a blended product mix.

These and other advantages of the present invention will be clarified in the description of the preferred embodiments taken together with the attached figures.

### BRIEF DESCRIPTION OF THE FIGURES

FIG. 1 is a schematic view of a hammer mill process for forming uniform foamed glass aggregate products according to one aspect of the present invention.

FIG. 2 is a schematic view of a pre-mill spray treatment used within the hammer mill process for forming uniform foamed glass aggregate products according to FIG. 1.

FIG. 3 is a schematic view of a method of forming blends of uniform foamed glass aggregate products formed in the hammer mill process for forming uniform foamed glass aggregate products according to FIG. 1.

FIGS. 4A and 4B are schematic views of representative blends of uniform foamed glass aggregate products formed in the hammer mill process for forming uniform foamed glass aggregate products according to FIG. 1.

### DESCRIPTION OF THE PREFERRED EMBODIMENTS

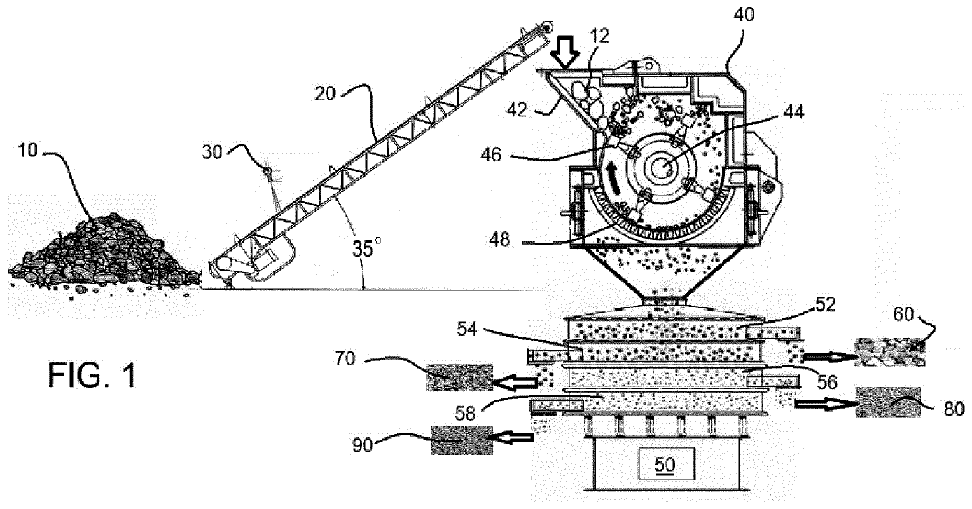

The present invention relates to a hammer mill process for forming uniform foamed glass aggregate products as schematically shown in FIG. 1. The process begins with conventionally formed foamed glass aggregate product 10.

As noted above foamed glass aggregate begins as post-consumer recycled glass. The recycled glass is cleaned to generally >99% cleaned glass which is milled into a superfine powder and mixed with a foaming agent prior to being kiln-fired.

Once the glass powder and foaming agent mixture is prepared, it's deposited onto a conveyor, which moves slowly through a kiln at a specific thermal profile to slowly heat the glass powder and foaming agent mixture to about 1,500°. The glass powder softens as it heats, causing a chemical reaction with the foaming agent that foams up the mixture and creates a network of closed cell micropores. After exiting the kiln, the material emerges as a thick foam glass slab from which the aggregate pieces 10 are formed with the particle sizes are about 1″-3″ in diameter, preferably about 1″-2″ in diameter; wherein the aggregate pieces 10 formed with the particle sizes of about 1″-3″ in diameter means that at least 80% of the particles (by weight) have particle sizes of 1″-3″ in diameter, and wherein the aggregate pieces 10 formed with the particle sizes of about 1″-2″ in diameter means that at least 80% of the particles (by weight) have particle sizes of 1″-2″ in diameter

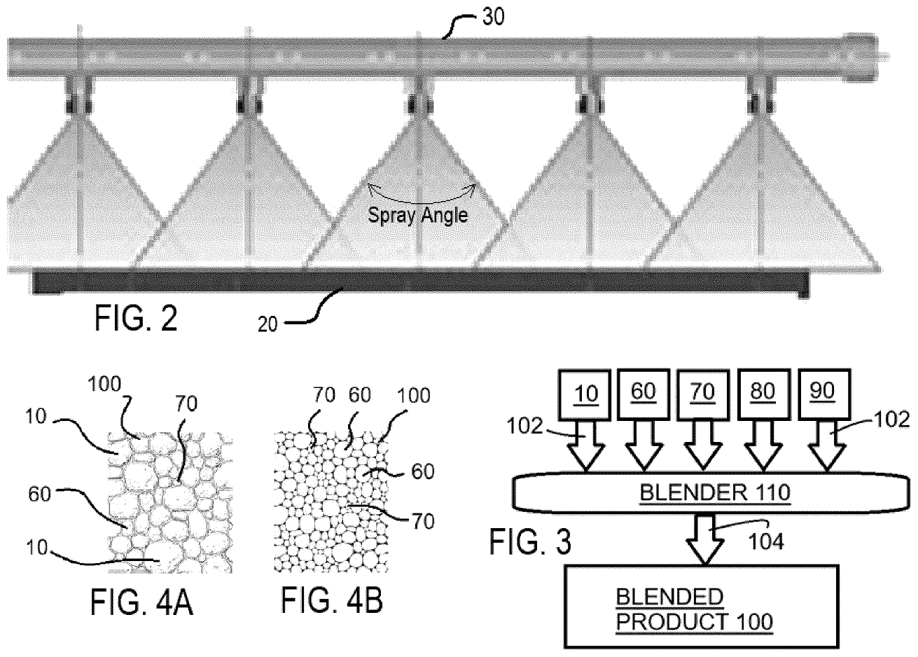

The aggregate pieces 10 are moved onto a conveyor 20 where they can be treated by treatment sprayer 30 with a pre-milling treatment, as shown in FIG. 2. The treatment sprayer 30 may utilize an aqueous solution for minimizing dust in the process. In one aspect of the invention, the aqueous solution applied by treatment sprayer 30 includes a waterborne resinous filler, possibly an adhesive, for filling the open pores of the aggregate pieces 10. Other treatments include a surface activation agent such as a surfactant, a sealant or other desired treatments. The treatment sprayer 30 can include multiple nozzles extending across the conveyor 20 as shown in FIG. 2. The operation and control of the treatment sprayer is generally known in the art.

The conveyor 20 feeds a horizontal hammer mill 40 and the use of the aggregate loading conveyor 20 allows for efficient handling and transporting the aggregate pieces 10 and the treated aggregate pieces 12 (those after the sprayer 30). Preferably, as shown, the conveyor 20 is a belt conveyor 20 which consist of a continuous belt that moves materials along the defined path and allows for incorporation of the treatment sprayer 30.

Aggregate loading conveyor 20 feeds the treated aggregate 12 to the input or feed hopper 42 of the horizontal hammer mill 40. The feed hopper 42 may use either gravity or a metered feeding system. In the generally preferred gravity feeding system, the mill 40 solely depends on the gravitational force to feed the treated aggregate 12 into the crushing chamber or tub grinder.

In the hammer mill 40, swinging hammer-heads 46 are attached to a rotor 44 that rotates at high speed inside a hard casing called the crushing chamber or tub grinder. The working principle of the hammer mill 40 operates on the principle of impact between rapidly moving hammers 46 mounted and treated aggregate pieces 12. The material is crushed and pulverized between the hammers 46 and the casing and remains in the mill until it is fine enough to pass through a sieve 48 that forms the bottom of the casing. Preferably the sieve 48 has a sieve size of less than or equal to 1½″, preferably 1⅛″ or 1″. The milling process mainly takes place in the crushing chamber which consists of a stout steel casing in which a central shaft of the rotor 44 is enclosed to the swinging hammers 46 are attached. When the shaft 44 is rotated by the motor the hammers 46 swing out. On the lower part of the casing, the sieve 48 of the desired size is fitted which can be easily replaced according to the largest particle size required. Users can switch ON/OFF the mill 40 from the control box. The operator may control a metered feeding system (if used) and motor speed of rotor 44.

The material exiting the mill 40 is directed to a four-chamber separator 50 that will separate into four product mixes 60, 70, 80 and 90. A first chamber 52 is separated from a second chamber 54 by a ¾″ sieve and has an outlet for product 60. Product 60 is a product mix with at least 80%, or at least 90%, and preferably at least 95% having particle size between ¾″-1″. Product mix 60 is formed of accurately sized particles that have enough flat surface area when place against another rock to create sufficient friction, improving compaction and stabilization applications, less void space. Product mix 60 may be used as an effective concrete filler and can be used with bae material aggregate.

The second chamber 54 is separated from a third chamber 54 by a ½″ sieve and has an outlet for product 70. Product 70 is a product mix with at least 80%, or at least 90%, and preferably at least 95% having particle size between ½″-¾″. Product mix 70 is formed of accurately sized particles that have enough flat surface area when place against another rock to create sufficient friction, improving compaction and stabilization applications, less void space. Product mix 70 may also be used as an effective concrete filler and can be used with bae material aggregate.

The third chamber 56 is separated from a fourth chamber 56 by a ⅜″ sieve and has an outlet for product 80. Product 80 is a product mix with at least 80%, or at least 90%, and preferably at least 95% having particle size between ¼″-⅜″. The fourth chamber 56 has an outlet for product 90 which is a product mix with at least 80%, or at least 90%, and preferably at least 95% having particle size less than ¼″.

The product mixes 60, 70, 80, 90 each provide a uniform mix of foamed aggregate product that be better suited for distinct applications. Further the product mixes 60, 70, 80, 90 together with the aggregate pieces 10 yield a method of forming engineered blends 100 of uniform foamed glass aggregate products. FIGS. 4A and 4B are schematic views of representative blends 100 of uniform foamed glass aggregate products formed from selected blends of the product mixes 60, 70, 80, 90 together with the aggregate pieces 10.

FIG. 3 is a schematic view of a method of forming blends 100 of uniform foamed glass aggregate products in which selected ratios of select product mixes 60, 70, 80, 90 together with the aggregate pieces 10 are fed at 102 to blender 110 to form the select engineered blends 100 exiting at 104 the blender 110. The feeds 102 are selectively controllable and metered to form precise blends 100. The formation of uniform product mixes 60, 70, 80, 90 can be used to form blends 100 improving the aggregate pieces 10. The specific combination of product mixes 60, 70, 80, 90 together with the aggregate pieces 10 can be varied as desired but the uniform mixes allow for precise combinations based upon desired properties (density, surface area, etc.). The blends 100 are simply not possible without the product mixes 60, 70, 80, 90.

These and other advantages of the present claimed invention will be understood by those of ordinary skill in the art and the spirit and scope of the present invention is defined by the appended claims and equivalents thereto.

What is claimed is:

1. A method for forming uniform foamed glass aggregate product comprising the steps of
a. providing a base foamed glass product;
b. feeding the base foamed aggregate product to a hammer mill having an outlet sieve;
c. processing the base foamed aggregate product in the hammer mill;
d. extracting foamed aggregate product from the hammer mill; and
e. separating the foamed aggregate product from the hammer mill into at least two product mixes of distinct diameter ranges.

2. The method for forming uniform foamed glass aggregate product according to claim 1, wherein the base foamed glass product is a foamed glass aggregate product.

3. The method for forming uniform foamed glass aggregate product according to claim 2, wherein the base foamed glass product is treated with an aqueous solution prior to processing the base foamed aggregate product in the hammer mill.

4. The method for forming uniform foamed glass aggregate product according to claim 3, wherein the aqueous solution is applied by a treatment sprayer and includes a waterborne resinous filler.

5. The method for forming uniform foamed glass aggregate product according to claim 3, wherein the hammer mill is a horizontal hammer mill with a gravity feed.

6. The method for forming uniform foamed glass aggregate product according to claim 3, wherein the step of separating the foamed aggregate product from the hammer mill is into at least three product mixes of distinct diameter ranges.

7. The method for forming uniform foamed glass aggregate product according to claim 3, wherein the step of separating the foamed aggregate product from the hammer mill is into at least four product mixes of distinct diameter ranges.

8. The method for forming uniform foamed glass aggregate product according to claim 7, wherein one product mix has at least 80% of the particles having particle size between ¾″-1″.

9. The method for forming uniform foamed glass aggregate product according to claim 8, wherein a second product mix is with at least 80% of the particles having particle size between ½″-¾″.

10. The method for forming uniform foamed glass aggregate product according to claim 9, wherein a third product mix is with at least 80% of the particles having particle size between ¼″-½″.

11. The method for forming uniform foamed glass aggregate product according to claim 10, wherein a fourth product mix is with at least 80% of the particles having particle size less than ¼″.

12. The method for forming uniform foamed glass aggregate product according to claim 7, wherein the step of separating the foamed aggregate product from the hammer mill includes directing the foamed aggregate product from the hammer mill to a four-chamber separator that will separate into four product mixes.

13. The method for forming uniform foamed glass aggregate product according to claim 7, further including the step of blending a plurality of the four product mixes into a blended foamed aggregate product.

14. The foamed aggregate product formed by the method for forming uniform foamed glass aggregate product according to claim 1.

15. A method of forming blends of uniform foamed glass aggregate products comprising the steps of providing at least four product mixes of foamed glass aggregate products of distinct diameter ranges comprising combining at least two of the product mixes of foamed glass aggregate products of distinct diameter ranges into a blended product mix.

16. The method of forming blends of uniform foamed glass aggregate products according to claim 15, wherein one product mix has at least 80% of the particles having particle size between ¾″-1″.

17. The method of forming blends of uniform foamed glass aggregate products according to claim 16, wherein a second product mix is with at least 80% of the particles having particle size between ½″-¾″.

18. The method of forming blends of uniform foamed glass aggregate products according to claim 17, wherein a third product mix is with at least 80% of the particles having particle size between ¼″-½″.

19. The method of forming blends of uniform foamed glass aggregate products according to claim 18, wherein a fourth product mix is with at least 80% of the particles having particle size less than ¼″.

20. The method of forming blends of uniform foamed glass aggregate products according to claim 19, further including the steps of
a. providing a base foamed glass product;
b. feeding the base foamed aggregate product to a hammer mill having an outlet sieve;
c. processing the base foamed aggregate product in the hammer mill;
d. extracting foamed aggregate product from the hammer mill; and
e. separating the foamed aggregate product from the hammer mill into the four product mixes of distinct diameter ranges.
